(19) United States
(12) Patent Application Publication
(10) Pub. No.: US 2024/0101457 A1
(43) Pub. Date: Mar. 28, 2024

(54) GREYWATER TREATMENT SYSTEMS

(71) Applicant: FRAFOID INC., Kingston (CA)

(72) Inventors: Cameron Stuart RUNTE, Kingston (CA); Michael Edward SHANNON, Picton (CA); Sreemannarayana MYPATI, Kingston (CA); Yang ZHOU, Richmond Hill (CA); Osayuki OSAZUWA, Kingston (CA); Sreemoyee GHOSH RAY, Kingston (CA)

(21) Appl. No.: 18/275,465

(22) PCT Filed: Feb. 2, 2022
(86) PCT No.: PCT/CA2022/050152

§ 371 Date: Aug. 2, 2023

Related U.S. Application Data
(60) Provisional application No. 63/144,733, filed on Feb. 2, 2021.

(51) Int. Cl. C02F 9/00; B01D 39/16; B01D 39/20; B01D 61/14; B01D 69/08; B01D 71/02

(52) U.S. Cl. CPC C02F 9/00; B01D 39/16; B01D 39/2055; B01D 61/145; B01D 69/08; B01D 71/0211; C02F 2103/002

(57) ABSTRACT

The present invention provides a multi-stage system for treating greywater comprising an electrochemical treatment module configured to carry out electrooxidation and electrocoagulation processes and a filtration module comprising a multistage filtration system for the treatment and removal of chemical and biological contaminants in greywater.

### FIELD OF THE INVENTION

The present invention pertains to the field of wastewater treatment and in particular to systems for treating greywater.

### BACKGROUND

There is an increasing demand for fresh water due to the population growth and urbanization. Even though 70% of the Earth is covered by water, only 2.5% is freshwater and only approximately 1% of our freshwater is accessible, while much of it is trapped in glaciers, polar icecaps, and soil. According to the 2018 edition of the United Nations World Water Development Report, nearly 6 billion people will suffer from clean water scarcity by 2050. This is mainly driven by increasing demand for water, reduction in natural water resources, and increasing pollution of water as a result of population and economic growth [https://www.nature.com/articles/s41545-019-0039-9, https://unesdoc.unesco.org/ark:/48223/pf0000261424]. To combat this growing problem, it is highly essential to reduce surface and groundwater use in all sectors and to substitute freshwater with alternative resources, such as treated greywater (GW) [http://iieng.org/images/proceedings_pdf/IAE0316411.pdf]. The greywater is defined as wastewater generated from bathtubs, hand wash basin, laundry and kitchen sink without any contributions from toilet water.

The composition of greywater varies, and it is largely a reflection of the lifestyle and choice of chemicals used for laundry, cleaning, and bathing. The quality of the household point-of-entry (POE) water supply and type of distribution network also affect the characteristics of greywater. Generally, greywater contains high concentrations of biodegradable organic materials (food wastes) including dissolved organic compounds (proteins, carbohydrates, and detergents) and total suspended solids (TSS) containing fat, oil, and greases (O&G), as well as constituents such as nitrates, phosphorus, biological microbes (faecal coliforms, salmonella, etc.), pharmaceuticals, health and beauty products, aerosols, dye pigments, and toxic heavy metals such as lead, nickel, copper, cadmium, mercury, and chromium. The physical appearance of greywater comes from factors such as temperature, turbidity, electrical conductivity, and suspended solids. The temperature normally ranges from 18 to 35° C. and the total suspended solids (TSS) within 150-600 mg/L (ppm). Greywater that originates from the kitchen (dishwasher, kitchen sink) and laundry accounts for the relatively high levels of TSS. The nitrogen content in greywater typically range between 4 and 74 ppm, while washing detergents are the primary source of phosphates which also range between 4 and 14 ppm. A final important factor in the GW quality depends on the pH and alkalinity in the water supply, which normally is within the pH range of 5-9. Greywater with most of its sources originating from laundry will generally exhibit high pH due to the presence of alkaline surfactant materials used in detergents [https://www.ncbi.nim.nih.gov/pmc/articles/PMC6133124/].

The greywater constitutes roughly 50-75% of water consumption. The amount of greywater produced can vary greatly depending on several factors which include geographical location, infrastructure, lifestyle, cultural habits, and climate conditions. The greywater produced is generally considered high volume, low strength waste with high potential for reuse and recycling applications. Treatment of greywater will range from simple to extremely complex techniques that include physiochemical, electrochemical or biological methods. Physiochemical methods use physical and/or chemical methods of treatment including filtration, adsorption, chemical treatment, and reverse osmosis, among others. Biological treatments will adopt a combination of microbes, sunlight, and oxygen manipulation; with examples including activated sludge systems, trickling filters, waste stabilization ponds, membrane bioreactors, and rotating biological contactors.

Electrochemical technologies, including include electrocoagulation, electrooxidation, and electroflotation, have received great attention for their effectiveness in treating different types of wastewater (Zhang et al. 2009). Electrochemical treatments are characterized by simple equipment, brief retention times, and easy operation, which can contribute to reduce the operating cost in large-scale applications (Rumeau 1989; Do and Chen 1994; Wendt and Kreysa 2001).

The electrocoagulation (EC) process has attracted great attention as one of the electrochemical technologies in wastewater treatment. It has been applied to remove phosphate from aqueous solutions (Bektas et al. 2004), decolorize dye solutions (Zhang et al. 2009), and treat textile wastewater (Kobya eta/. 2003; Bayramoglu et al. 2007). Several authors (Chen et al. 2000a, b) applied EC and electrocoagulation-electroflotation (EC-EF) processes to remove colloids, TSS, fat, and oil and grease (O&G) from restaurant wastewaters. In EC processes, a coagulant agent is generated in situ via anodic dissolution of aluminum or iron electrodes. The metal ions form (Fe²⁺, Fe³⁺ or Al³⁺) flocculate contaminants and the hydrogen bubbles (H₂) produced at the cathode transport light solids and hydrophobic materials, such as fat and O&G, to the surface of the liquid where they are skimmed. The combination of the electroflotation process with the electrocoagulation process increases the flotation of flocks formed in the electrocoagulation unit.

Electrooxidation (EO) is an electrochemical technique that also can be applied to remove dissolved pollutants from waters. The pollutant can be directly and indirectly oxidized (Linares-Hernàndez et al. 2010). Direct anodic oxidation ensures the removal of pollutant at the surface of the electrode, whereas indirect anodic oxidation allows the in situ generation of oxidants such as HCIO, H₂O₂, HBrO, and O₃ (Linares-Hernàndez et al. 2010). According to Zaviska et al. (2009), electrolytic production of chlorine is one of the industrial electrochemical reactions. In the solution, chloride ions can be oxidized at the anode and form hypochlorous acid (HCIO), which is a powerful oxidant.

There is a need for low maintenance greywater treatment systems having a small footprint and short treatment retention times, and which are modular in design to provide flexibility in installation.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide greywater treatment systems. In accordance with an aspect of the present invention, there is provided an electrochemical treatment module for the electrooxidation and electrocoagulation treatment of contaminants in greywater, the electrochemical treatment module comprising: a tank having a bottom, a top, a first and a second end; a plurality of first electrooxidation electrodes; a plurality of second electrocoagulation electrodes; a waste water inlet located at the first end of the tank; a discharge outlet located at the second end of the tank; and a plurality of air/aeration inlets located along the bottom of the tank; wherein the electrochemical treatment tank is configured to oxidize and coagulate chemical contaminants for removal by sedimentation.

In accordance with another aspect of the present invention, there is provided a multi-stage system for treating greywater, the system comprising: an electrochemical treatment module in accordance with the present invention, configured for the electrooxidation and electrocoagulation treatment of chemical contaminants in greywater; a pretreatment module for removing oil and grease from the greywater prior to treatment in the electrochemical treatment module; and a filtration module for removing particulate and microbial contaminants and dissolved chemicals from the greywater following treatment in the electrochemical treatment module.

### BRIEF DESCRIPTION OF THE FIGURES

FIG. 1 is a schematic depiction of a household greywater treatment system, in accordance with one embodiment of the present invention.

FIG. 2 is a schematic depiction of a multistage greywater treatment system, in accordance with one embodiment of the present invention.

FIG. 3 is a schematic depiction of an electrochemical treatment tank, in accordance with one embodiment of the present invention.

FIGS. 4A and 4B are schematic depictions of electrochemical treatment modules, in accordance with embodiments of the treatment system of the present invention.

FIG. 5 is a schematic depiction of a beaker scale configuration for a study for optimizing electrochemical treatment reaction conditions.

FIG. 6 is a graphical depiction of the effect of varying current density and reaction time in the electrochemical treatment optimization study.

FIG. 7 is a graphical depiction of the effect of different electrodes on the electrochemical treatment reaction.

FIG. 8 is a graphical depiction of the effect of varying flow rate, current density and filtration method on reduction of COD.

FIGS. 9A to 9C are different views of a greywater treatment system, in accordance with one embodiment of the present invention.

### DETAILED DESCRIPTION OF THE INVENTION

The term “greywater” is defined as wastewater generated from bathtubs, hand wash basin, laundry and kitchen sink without any contributions from toilet water.

The term “blackwater” is defined as wastewater generated from toilet water or which may contain pathogens that render it unsuitable for consumption and that must be treated before release into the environment.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a multistage system for treating greywater. In a preferred embodiment, the system comprises 3 stages, wherein stage 1 is a primary treatment module for removing grease and particulate matter, stage 2 is a secondary treatment module employing electrochemical treatment steps followed by a rapid sedimentation of particulate pollutants, and stage 3 is a tertiary treatment module providing a series of filtration steps for removing any residual particulate matter and microbes (bacteria and fungi) and dissolved chemicals present after stage 2.

The use of the present multistage system provides the capability of not only treating greywater (including the water from kitchen, laundry and sanitation) for reuse in toilet flushing, gardening, floor mopping and car washing, it can also treat the water to achieve a drinking water standard that can be used for cooking, drinking and sanitation purposes as well.

The pollutants present in household greywater can include oil and grease from kitchen waste, and surfactants present in soaps and detergents, all of which are not easily removable in a single step process.

Treatment of greywater for reuse advantageously leads to a reduction in the need for fresh water, which can significantly reduce household water bills, while also reducing demands on public water supply. Treatment of greywater also leads to a reduction in the amount of wastewater entering sewers or on-site treatment systems.

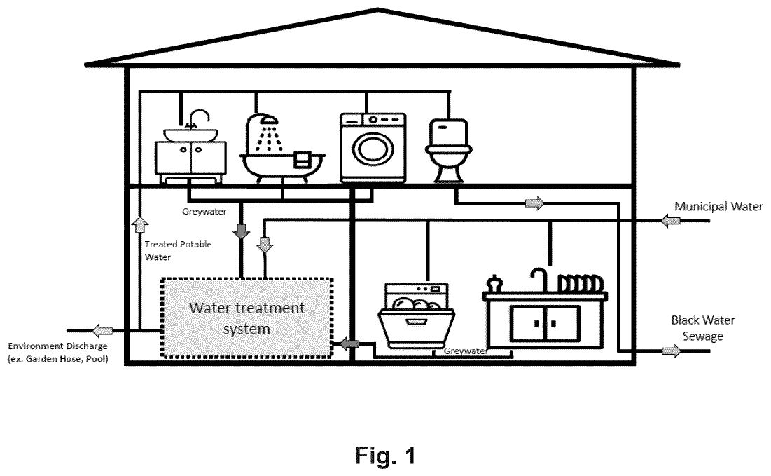

The flow diagram depicted in FIG. 1 shows a typical configuration for household greywater treatment systems, including greywater collected from different fixtures in the household, municipal water entering the house to compensate the needs for direct consumption, and treated water being resupplied to the house. The system of the present invention can achieve the NSF drinking water quality standard that can further improve the quantity of reusable water. The system of the present invention can also be expected to substantially increase the recycling efficiency by allowing for the re-use of the treated water at atypical locations such as laundry machine, showers, and bathroom sink fixtures in addition to the standard locations that existing decentralized greywater treatment technologies are capable of servicing with recycled water (i.e. toilets and environmental discharge).

Based on a strategy of collecting, treating, and re-distributing greywater with water quality exceeding the NSF 350 certification standard (i.e., suitable for non-potable applications such as surface and subsurface irrigation and toilet and urinal flushing), and ideally demonstrating compliance with NSF P231 and 53 certifications for the microbiological drinking water standards and relevant specific claims for chemical reduction performance, respectively, the expected performance with using the present water treatment system is that up to 65% of input water (from the municipality, or from a well, for example) can be recycled within the home.

The use of the system of the present invention can assist in reducing the environmental impact of households or commercial buildings, primarily by reducing the volume of water burden that municipal, centralized treatment facilities have to handle on a daily basis. This will lead to preserving infrastructure and saving taxpayer dollars on costly infrastructure renovation/construction projects.

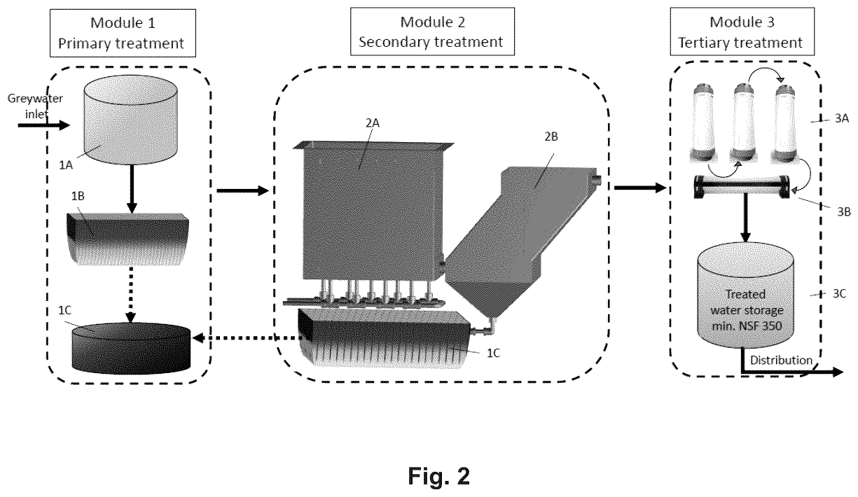

An exemplary multistage system in accordance with the present invention is shown in FIG. 2. As shown, Module 1 of the multistage system includes collection tank 1A, fat/oil/grease (FOG) interceptor 1B and a tank 1C for collecting concentrated waste from the FOG interceptor and the sludge collector of Module 2.

In accordance with the present invention, the Module 1 of the multistage system includes a primary treatment (or pretreatment) stage for removing fats, oils and grease and particulate matter. Module 1 also includes a holding tank for holding greywater prior to introduction into the second stage.

In one embodiment, the primary treatment stage is any grease interceptor or grease trap as is known in the art.

After the fats, oils and grease have been removed, the de-greased greywater is pumped into Module 2 of the system, where it undergoes electrochemical treatment in an electrochemical treatment module.

As shown in FIG. 2, Module 2 of the multistage system includes electrochemical reactor 2A, rapid sedimentation tank 2B, and sludge collector 2C.

The electrochemical treatment module comprises an electrochemical treatment tank configured to subject the de-greased greywater input to an electrochemical treatment step.

In a preferred embodiment, the electrochemical treatment step comprises a combination of electrocoagulation (EC) and electrooxidation (EO) processes. In a further preferred embodiment, the EC and EO processes are carried out at the same time in the same primary treatment tank, thus allowing for the simultaneous removal of both insoluble and soluble pollutants from the greywater being treated.

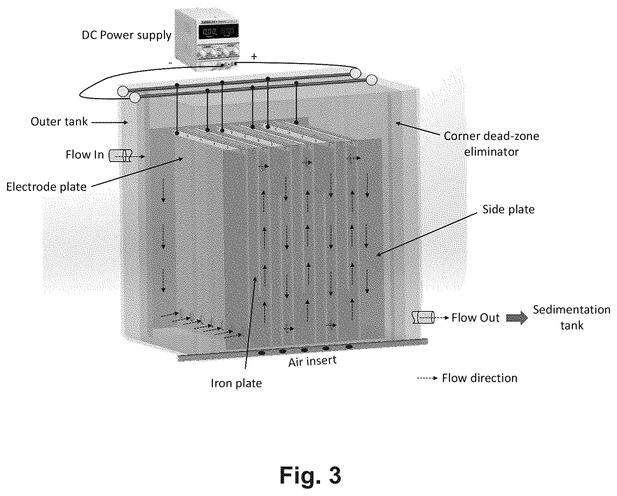

FIG. 3 is a schematic depiction of one embodiment of an electrochemical treatment tank suitable for use in the present treatment system.

The electrochemical treatment tank also comprises a plurality of first electrodes and a plurality of second electrodes. In one embodiment, the first electrodes are electrooxidation electrodes and the second electrodes are electrocoagulation electrodes.

In one embodiment, the first set of electrodes are grouped together in sequential arrangement, followed by the second set of electrodes, also grouped together in sequential arrangement.

In one embodiment, the first and second sets of electrodes are sequentially arranged in alternation.

The first set of electrodes, or electrooxidation electrodes, are directly connected to a direct current power supply in a constant current mode with alternate positive and negative electrodes. In one embodiment, the first electrodes are planar electrodes comprising carbon-based materials boron doped diamond, mixed metal oxides, or any combination thereof.

The second set of electrodes, or electrocoagulation electrodes, may be arranged in two different configurations.

In a first configuration, the plurality of electrooxidation electrodes having both positive and negative electrodes are arranged sequentially, followed by the plurality of electrocoagulation electrodes connected to a different direct current power supply in constant current mode with alternate positive and negative electrodes.

In a second configuration, the electrocoagulation electrodes are inserted parallel between the electrooxidation electrodes and are not connected to any power supply. In this configuration, the electrocoagulation electrodes behave as a bipolar and sacrificial electrode.

In one embodiment, the electrocoagulation electrodes are planar electrodes comprising aluminum, iron, or mild (low carbon) steel.

The thickness of the electrode can range from few microns to few millimeters depending on the life of the tank or depending on the maintenance schedule for the reactor. In a preferred embodiment, less thick electrodes are employed to avoid pitting or extreme corrosion during the operation of the reactor.

The spacing between the electrodes can be in the range of few millimeters to 5 cm. This spacing and electrode thickness determine the groove dimensions in the side plate.

At the top of each electrode, an electrical connector made from a highly conductive but non-corrosive material such as copper or brass. In one embodiment, the electrical connector has a width in the range of about 0.5 cm to about 2 cm to facilitate the uniform charge distribution. In one embodiment, the electrical connector is connected to the electrodes with stainless steel nuts and bolts.

In one embodiment, both ends of the direct current power supply can be connected to the electrooxidation and electrocoagulation electrodes in an alternate arrangement via common electrical connection. A polarity switch is recommended each batch (to preserve electrode material lifetime automatic control of this switching via the power supply during the operation at a fixed interval ranging from 5 mins to 30 mins).

In one embodiment, the electrical connections are made in parallel to ensure the operation even in the event of a single electrode failure.

In one embodiment, the first and second electrodes are provided in an electrode core, which is a modular fixture configured for insertion and removal from the tank for electrode maintenance.

The electrode core consists of a non-conductive side plate on opposing sides of the electrodes, configured to hold the electrodes securely in position. In one embodiment, each side plate consists of grooves extending from top to the bottom, configured to receive the electrodes via insertion. In one embodiment, the side plates are prepared from a non-conductive material to avoid short circuiting of electrodes during the operation. If a metal side plate is used, a non-conductive coating is employed, or a gasket is provided in each groove to avoid the contact between electrodes and side plates.

The electrode core and the interior walls of the tank are watertight to avoid water seepage between them. In one embodiment, this can be achieved by providing gasket material or making the electrode core side plates fixed on to the interior of tank with a provision to access when required.

In one embodiment, the electrodes are arranged to ensure a continuous serpentine flow through the tank to ensure maximum exposure time of the water undergoing electrochemical treatment to the surface of the electrodes.

In one embodiment, unidirectional continuous flow through the treatment tank is ensured through the use of gaps between the ends of electrodes and the tank walls and/or the use of holes in in the electrodes.

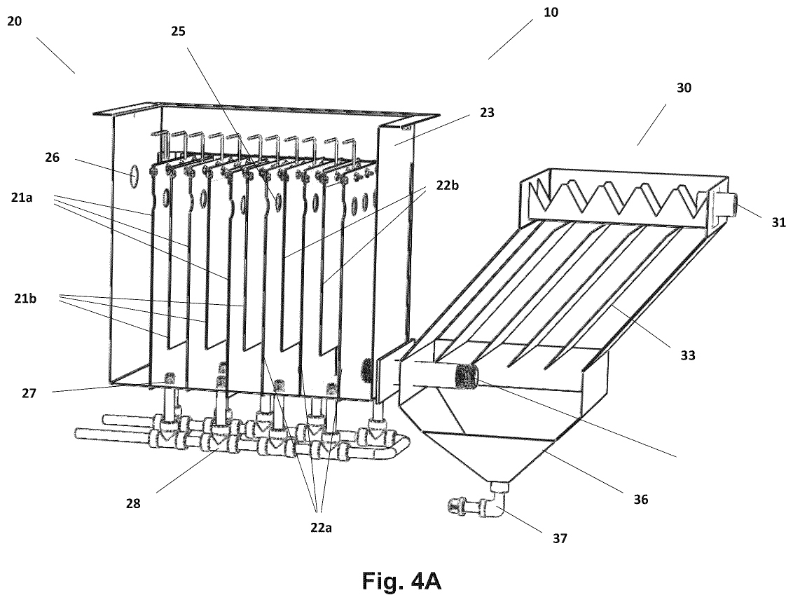

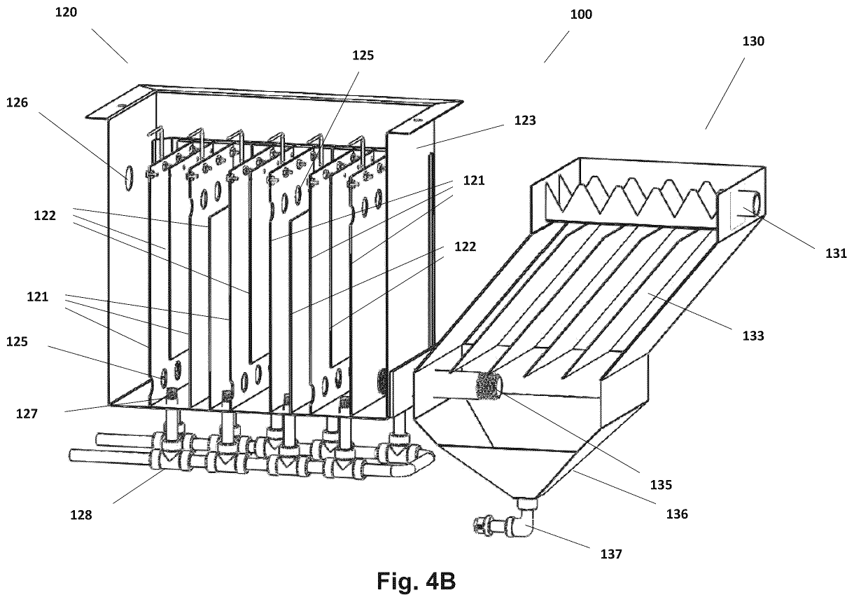

In one embodiment, unidirectional continuous flow through the treatment tank is achieved through the use of short electrodes that create a gap between the end of the electrode and the tank wall arranged in alternation with full length electrodes having holes on the end opposite to the gap, as shown in FIG. 4A.

In one embodiment, where the electrooxidation and electrocoagulation electrodes are provided in alternation, unidirectional continuous flow through the treatment tank is achieved by directing the water through holes made on each electrooxidation electrode. The holes are to be either at the bottom or at the top of electrooxidation electrodes that are fixed alternately, as shown in FIGS. 3 and 4B.

Where bipolar sacrificial electrocoagulation electrodes are employed, these electrodes also are arranged to ensure the serpentine flow in the reactor to maximize the contact time between the water undergoing electrochemical treatment and the electrodes. In one embodiment, the electrocoagulation electrodes are provided as short electrodes providing a gap between the end of the electrode and the tank wall.

In one embodiment, each hole is at least about 2 cm in diameter.

In one embodiment, the electrooxidation electrodes of the present invention comprise a carbon-based material. Carbon-based materials that may be incorporated into the electrooxidation electrodes of the present invention include nanostructured carbon materials such as graphene, graphene nanoplatelets, carbon nanotubes (single- and multi-wall), and carbon nanofibers, as well as non-nanostructured carbon-based materials such as graphite, expanded graphite, flake graphite, graphite plate, and carbon black.

In one embodiment, to enhance the capabilities of generating oxidants for pollutants removal, the electrodes can be coated with catalyst materials like titanium oxide, tin oxide, etc.

In one embodiment, the electrooxidation electrodes comprise graphene-enhanced carbon hybrid composites containing a mixture of graphene and carbon compounds in a binder.

In one embodiment, the electrooxidation electrodes are formed on a mesh support such as copper, aluminium, or steel. In one embodiment, the electrooxidation electrodes comprise multiple layers of metal mesh and composites held together in a sandwich-like structures, optionally with graphite plates.

In one embodiment, the carbon materials are bound together to form the electrooxidation electrodes through the use of adhesives or binders, such as PTFE, thermosetting resins (epoxy, phenolic), pitch, or the like.

In one embodiment, the composite sheets and sandwich structures may be subjected to intense heat and pressure in an inert or reducing atmosphere to eliminate volatile materials and convert all organic compounds carbon. Specifically, samples may be compressed at least 4000 psi and held at temperatures of 600° C. or higher in a furnace overnight.

In one embodiment, the treatment tank is formed from a rectangular or cylindrical exterior tank shell having a volume of from about 100 L to about 5000 L. If a rectangular tank design is chosen, the corners of the tank should be blocked or filled to avoid dead-zones in the tank where the water stagnates or doesn't flow.

In one embodiment, the treatment tank is manufactured from a polymer material including but not limited to glass fiber or food grade polymers, or a metal. If a metal tank is used, a non-conductive and noncorrosive coating such as a polymer resin like polyurethane, or silicone rubber, is mandatory.

In accordance with the present invention, the tank is not under pressure but is designed for a continuous flow where the de-greased greywater is pumped into the tank through a wastewater inlet at the first end of the tank, and leaves through a discharge outlet located at the opposing second end of the tank. The flow rate is determined by the treatment time, current applied to the electrodes, and the chemical composition of the water undergoing electrochemical treatment, flow rates can vary starting at a minimum of 0.5 L/min.

In one embodiment, the electrochemical treatment tank comprises a plurality of air/aeration inlets located along the bottom of the tank to provide an external air supply to maintain an adequate oxygen level in the water undergoing electrochemical treatment during the treatment process and to reduce the sludge accumulation at the bottom of the treatment tank.

In one embodiment, the discharge outlet of the electrochemical treatment tank is connected to a chemical flocculant source, which is discharged into an inline static mixer to ensure the required particle size for effective sedimentation, prior to discharge into the sedimentation tank. Suitable flocculant materials include, but are not limited to, alum or chemical polymers.

### Sedimentation Tank:

In accordance with the present invention, the greywater, after treatment in the electrochemical treatment tank, contains oxidized and coagulated/flocculated chemical contaminants, and is passed out of the discharge outlet into a sedimentation tank, where the coagulated/flocculated particles are removed by sedimentation.

In one embodiment, the sedimentation tank is a parallel plate settler. In one embodiment, the sedimentation tank is operated in continuous mode by providing a continuous dripping of sludge from bottom of the sedimentation tank.

In one embodiment, the tank is made from a polymer based material or metal with a non-corrosive coating on the interior of the tank.

In one embodiment, to maintain a uniform flow and to avoid disturbing the sludge blank at the bottom the tank, a perforated sheet with multiple orifices are made and connected to the inlet point. In one embodiment, the sedimentation tank has a V-shaped hopper bottom.

In one embodiment, the parallel plates inside the tank are inserted into premade grooves in the angular section of the tank. In one embodiment, the angle for the plates is maintained between 45-60 degrees. In one embodiment, the angle for the hopper bottom is in the range of the 45-55 degrees. In one embodiment, the parallel plates are made from acrylic material or high density polyethylene or stainless steel with smooth surface.

FIG. 4A depicts a cross sectional view of components of an electrochemical treatment module 10 in one embodiment of the invention, including the electrochemical treatment tank 20 and the sedimentation tank 30. The electrochemical treatment tank 20 includes an array of first electrooxidation electrodes 21a and 21b and second electrocoagulation electrodes 22a and 22b, arranged within tank shell 23. De-greased greywater is introduced into tank 20 through wastewater inlet 26, and flows in a serpentine flow pattern through the tank past the electrodes and through gaps created by short electrodes (e.g., electrooxidation electrodes 21b and electrocoagulation electrodes 22b) and through flow openings 25 located in alternating electrodes (e.g., in electrooxidation electrodes 21a and electrocoagulation electrodes 22a). An array of aeration nozzles 27 are located along the bottom of treatment tank 20 to introduce air from air line 28 to provide aeration to the water being treated to maintain an adequate oxygen level and to reduce the sludge accumulation at the bottom of the tank. After treatment of the de-greased greywater in treatment tank 20, it passes through discharge outlet 35 into sedimentation tank 30. The sedimentation tank 30 comprises a plurality of settling plates 33 which provide surfaces on which the coagulated/flocculated chemical contaminants can accumulate and settle on the hopper shaped bottom 36 of the sedimentation tank as a sludge, which is then removed through sludge outlet 37.

FIG. 4B depicts a cross sectional view of components of an electrochemical treatment module 110 in one embodiment of the invention, including the electrochemical treatment tank 120 and the sedimentation tank 130. The electrochemical treatment tank 120 includes an array of first electrooxidation electrodes 121 and second electrocoagulation electrodes 122, arranged in alternating sequence within tank shell 123. De-greased greywater is introduced into tank 120 through wastewater inlet 126, and flows in a serpentine flow pattern through the tank past the electrodes and through flow openings 125 located in electrooxidation electrodes 121. An array of aeration nozzles 127 are located along the bottom of treatment tank 120 to introduce air from air line 128 to provide aeration to the water being treated to maintain an adequate oxygen level and to reduce the sludge accumulation at the bottom of the tank. After treatment of the de-greased greywater in treatment tank 120, it passes through discharge outlet 135 into sedimentation tank 130. The sedimentation tank 130 comprises a plurality of settling plates 133 which provide surfaces on which the coagulated/flocculated chemical contaminants can accumulate and settle on the hopper shaped bottom 136 of the sedimentation tank as a sludge, which is then removed through sludge outlet 137.

Although the present disclosure illustrates the removal of residual particles using a sedimentation tank, it is within the scope of the present invention to incorporate alternative methods of particulate removal, including but not limited to centrifugation methods, the use of a sludge dewatering filter press, and the like.

After removal of the coagulated/flocculated chemical contaminants in the sedimentation step, the electrochemically treated greywater is passed into Module 3 (schematically represented by FIG. 2), where it passes through a sequence of filtration stages, including Stage 3A, which can include filtration elements suitable for removing micron sized particles remaining after sedimentation, ion exchange resins, and absorbent filtration elements suitable for removing residual dissolved chemicals, and ultra/nanofiltration Stage 3B comprising filtration elements for removing nanoparticulates including microbial contaminants. In one embodiment, the filtration module incorporates one or more of the components of the modular filtration system disclosed in WO12020/257950, the disclosure of which is incorporated herein by reference in its entirety.

In a preferred embodiment, Module 3 comprises a multistage filtration system comprising a series of filtration elements that together remove residual microbial and dissolved chemicals from the greywater following treatment in the electrochemical treatment module.

In one embodiment, the first filter stage of Module 3 includes a filtration element suitable for removing micron sized particles remaining after the sedimentation step carried out in Module 2. In one embodiment, this filtration element is a polypropylene filter.

In one embodiment, following removal of the micron sized particles, the second filter stage of Module 3 comprises passing the water through an activated carbon/ion exchange resin filter stage.

In one embodiment, the third filter stage of Module 3 comprises a carbon filter. In a preferred embodiment, the carbon filter further comprises at least one graphene-based filter material. In one embodiment, the graphene-based filter material comprises graphene and/or graphene oxide. In one embodiment, the graphene is few layer graphene, and the graphene oxide is few layer graphene oxide. In one embodiment, the third filter stage comprises two or more filter cartridges, wherein the cartridges may be different or the same.

The third filter stage is employed to remove dissolved chemical contaminants. In one embodiment, the third filter stage comprises a graphene-enhanced carbon filter cartridge containing at least one graphene-based material, which is particularly suitable for adsorbing and/or absorbing dissolved chemicals, including but not limited to organic compounds such as phenolic compounds, organic dyes, oil contaminants, volatile organic compounds, petrochemical compounds, and pharmaceutical drug molecules that can lead to undesirable colour and/or odour, as well as inorganic compounds such as ammonia, nitrite and dissolved metals including heavy metals.

In one embodiment, the graphene material is Mesograf™, which is a graphene comprising bilayer, trilayer, and few layer (up to 5 graphene layers) graphene nanoparticles having a flake size of 1-1000 microns, distributed within an overall powder-like state.

In one embodiment, the fourth filter stage of Module 3 comprises an ultrafiltration membrane having an average pore opening diameter of from about 8 nm to about 20 nm.

In one embodiment, the fourth filter stage comprises a hollow fiber ultrafiltration membrane. In a preferred embodiment, the hollow fiber membrane is a graphene-enhanced hollow fiber membrane. The fourth filter stage is preferably configured to remove any nanoparticle contaminants from the third filtrate to provide the final purified water product. The fourth filter stage is provided to mechanically remove any particles that are too small to be captured by the previous filter stages, including for example, small viruses or greater than 20 nanometer-scale sized particles.

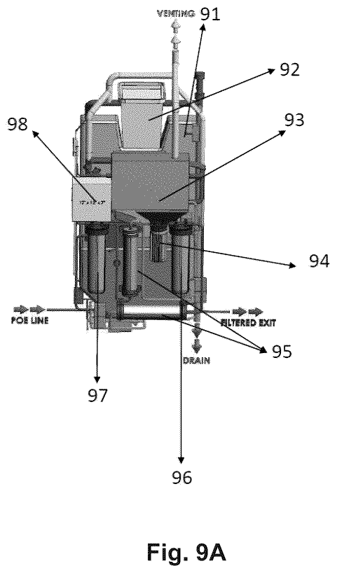

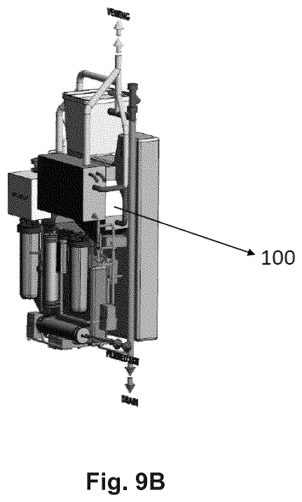

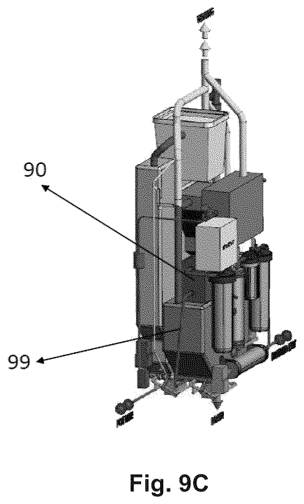

FIGS. 9A-C illustrate an embodiment of a greywater treatment system in accordance with the present invention. The system include components of Module 1, including a first storage tank 91 for storage of greywater before treatment and FOG trap 92. Components of Module 2 include electrochemical reactor 93, rapid settling tank 100. The different components of filter Module 3 are also shown, including polypropylene cartridge 97, activated carbon-ion exchange resin cartridge 96, a graphene enhanced carbon filter 94, graphene enhanced hollow fiber ultrafiltration membranes 95 and second storage tank 99 for storage of treated water. Also shown is water pump 90 for pumping water from Module 2 into Module 3 control and power supply module 98. As shown in FIGS. 9A-C, all components of the greywater treatment system occupy a small footprint and therefore the system of the present invention is particularly suitable for treatment of household greywater.

In one embodiment, the treatment system further includes smart sensing features and data collection software to track conservation and water quality statistics (for ensuring safety), allowing for full visibility in case of a component failure that requires technical attention and/or replacement, as well as to allow monitoring of treatment volumes for regular maintenance schedules. In one embodiment, the system is configured for continuous, automated treatment of greywater.

Although the present disclosure describes the implementation of the treatment system in the context of treating household wastewaters, it is not intended to be limited to single households, but can be scaled up to be suitable for use in other contexts with minor modifications in design and materials, including, but not limited to, communities of multiple households, old age homes, office buildings, retail spaces, apartment complexes and for small scale industrial projects.

### EXAMPLES

### Example 1: Synthetic Greywater

A synthetic greywater containing the ingredients listed in Table 1 was prepared for evaluating the performance of components of the greywater treatment system. The synthetic greywater has the following specifications:
COD=350-400 mg/l
Turbidity=120 NTU
TDS=250 ppm
Conductivity=0.45-0.5 mS/cm

TABLE 1

| | Amount | |
|---|---|---|
| Chemical | (g) per 10 L | |
| Johnson's Baby Moisturizing Baby Wash | 1.5 | g |
| Colgate Total Toothpaste | 0.15 | g |
| Gillette Antiperspirant Deodorant for Men | 0.05 | g |
| Secret Invisible Ph Balanced Baby Powder Antiperspirant | 0.05 | g |
| Suave Shampoo | 0.95 | g |
| Suave Conditioner | 1.05 | g |
| Lysol Bathroom Cleaner Spray | 0.5 | g |
| Dial Spring Water Antibacterial Hand Soap | 1.15 | g |
| Latic acid | 0.15 | g |
| Tide Ultra Oxi Liquid Detergent | 2 | g |
| Downy Fabric Conditioner (Fabric Softener) | 1.05 | g |
| Kaolin | 1 | g |
| Na₂SO₄ | 0.2 | g |
| NaHCO₃ | 0.1 | g |
| Na₃PO₄ | 0.2 | g |

### Example 2: Evaluation of Electrochemical Treatment Process—Beaker Scale

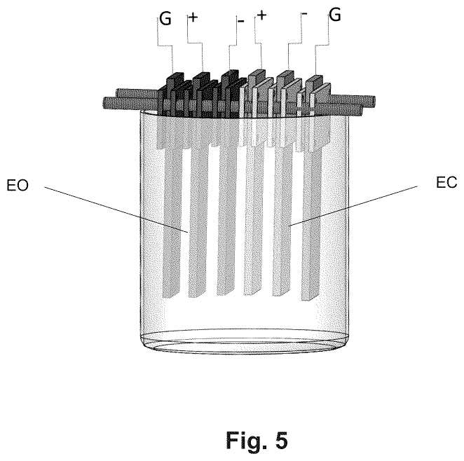

Preliminary evaluation of electrochemical reaction conditions was carried out on a 2 L sample of a synthetic greywater as prepared in Example 1, i.e., on a “beaker scale”. FIG. 5 is a schematic depiction of the beaker scale reactor employed in this example, including a set of electrooxidation (EO) electrodes and a set of electrocoagulation (EC) electrodes. Using the beaker scale reactor, current density (applied current) and reaction time were varied to determine the effect on removal of contaminants from the synthetic greywater sample. To utilize the total active surface area of EC and EO electrodes, the electrode plates at the ends are connected to a ground (G).

The current densities and time of treatment required for electrocoagulation and electrooxidation process were optimized using a statistical approach (central composite design). The experiments were carried out using iron and/or aluminum electrodes as anode and cathode for the electrocoagulation (EC), and commercial graphite electrode for the electrooxidation (EO). The current density for EO is varied between 6-12 mA/cm² (0.6-1.2 A), and for EC is 4.5-9 mA/cm² (0.45-0.9 A). The input current for EC and EO are independently provided by two separate power supplies. The treatment time is varied between 15 to 50 mins. The volume of the beaker is 2 L and 1 pair of electrodes is used for each electrochemical process.

The following operating conditions were maintained for all optimization experiments. A polarity switch for the electrodes (both EC and EO) was initiated at the half-time point of the treatment. The active surface area of electrodes is 100 cm² and spacing between the electrodes is 1 cm. Aeration was carried out during the experiment to maintain the dissolved oxygen in the water. The water sample, after electrochemical treatment, was allowed to rest undisturbed to allow for gravity settling of particulate matter, followed by filtration using a 0.2 micron nylon filter prior to analysis of the resulting water sample. The effluent quality of water is tested for pH, chemical oxygen demand (COD), total dissolved solids (TDS), and turbidity.

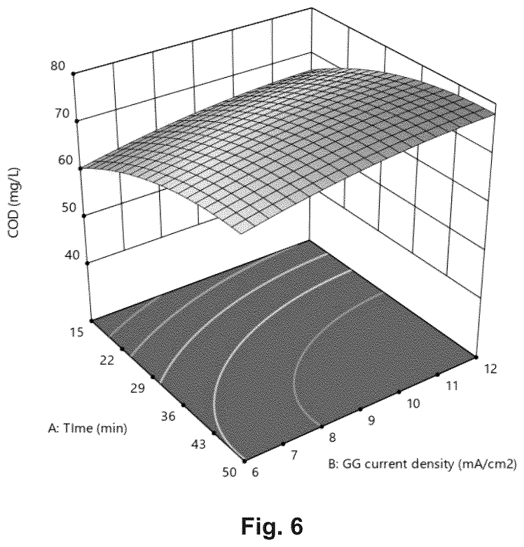

From the results, it was observed that 30 min operation at 12 mA/cm² for EO and 8 mA/cm² for EC resulted in 75% COD removal, 98% phosphate removal, pH was between 7-8 and TDS was below 400 ppm. FIG. 6 shows the percentage of COD removal with respect to varying time and current density of EO, at a fixed current density of 8 mA/cm² for EC.

In the optimization process for EC, it was observed that the best results are obtained when iron and aluminum electrodes are used together during the operation. The results also showed some of the water quality parameters after treatment are well with in the NSF 350 standard for reuse except for COD.

Table 2 provides a summary of a series of experiments for the electrochemical treatment of the synthetic greywater conducted using different electrocoagulation electrode combinations (EC current: 0.9 A) with graphite/graphite (G/G) electrooxidation electrodes (EO current: 0.68 A) for a period of 62 minutes.

TABLE 2

| Electrode | | | | | | |
|---|---|---|---|---|---|---|
| configuration | Conductivity | TDS | Turbidity | COD | Nitrates | Phosphates |
| Cathode/anode | (mS/cm) | (mg/l) | (NTU) | (mg/L) | (mg/l) | (mg/l) |
| Fe/Fe | 0.39 | 0.2 | 0.42 | 122 | 0.4 | <0.002 |
| Fe/Al | 0.33 | 0.17 | 2.14 | 105 | 0.3 | 0.005 |
| Al/Al | 0.37 | 0.16 | 1.8 | 155 | 0.3 | 0.004 |

### Example 3: Preparation of Composite EO Electrodes

### Powder Mixinq and Compression Moldinq

Activated carbon, MesoGraf and graphite adhesive (typical formulation amounts are shown in Table 3) were charged into a beaker or similar vessel and stirred for 15 minutes to a consistent paste. Mechanical stirring can be carried out manually or using a high shear mixer, depending on the total amount of material.

The homogenous carbon paste was poured into a mold and placed between two aluminum plates. The arrangement of aluminum plates with the carbon paste sandwiched between them was placed between the heated platens of a compression molding machine and pressed at the curing temperatures of the graphite adhesive or binder for 2-4 hours. Curing temperature was set from 150-250° C. at a pressure of 2000 psi depending on the graphite adhesive used.

After curing, heating of the platens was turned off and the sample was left to cool down to ambient temperatures under sustained pressure. The resulting composite plate has a typical dimension of 15×15×0.5 cm³ and was cut lengthwise to form 3 pieces per plate, the final dimensions of the electrodes measuring 15×5×0.5 cm³.

### Example 4: Testing of Composite Electrodes

Four sample electrodes and a commercial graphite electrode were tested and compared. Samples 12 and 14 contain graphite and Mesograf, while Samples 11 and 13 contain only graphite. With respect to the adhesive component, Samples 11 and 12 contain Aremco Graphi-Bond 551-RN-MV, and Samples 13 and 14 contain Ceramaterials EBS-1X (See Table 3). Mesograf was incorporated as a catalyst to achieve better oxidation reactions when combined with conductive binders.

Test conditions: Al/Al=8 mA/cm², GG=12 mA/cm², retention time=30 min, polarity change=none.

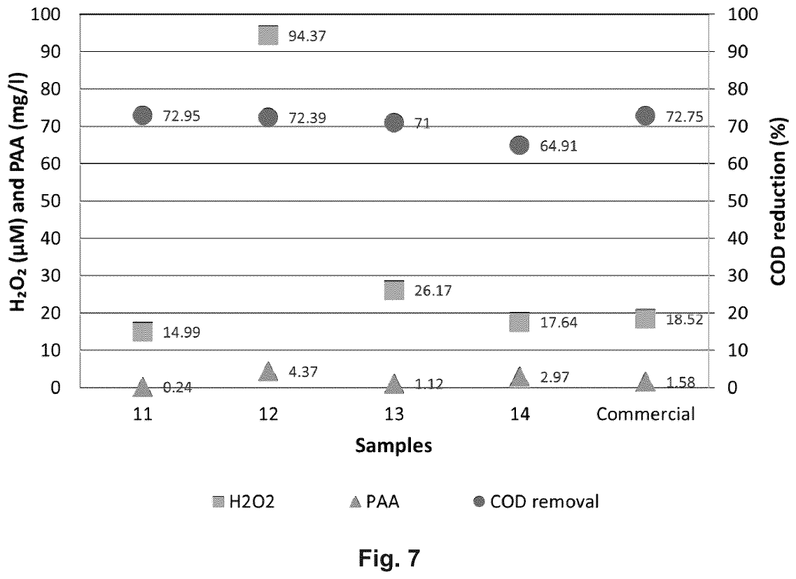

The in situ generation of highly oxidative peracetic acid (PAA) and H₂O₂ by the electrodes was evaluated. The results are summarized in FIG. 7. Mesograf with Aremco binder (Sample 12) in EC/EO process generated the maximum concentration of PAA and H₂O₂ as 4.37 mg/l and 94.37 μM, respectively.

TABLE 3

| | Composition (wt. %) | | | | | |
|---|---|---|---|---|---|---|
| | | | Carbon | Carbon | | Total |
| | Graphite | MesoGraf | nanotubes | black | Binder | Weight |
| Sample | (g) | (g) | (g) | (g) | (g) | (g) |

Aremco Graphi-Bond 551-RN-MV

| | | | | | | |
|---|---|---|---|---|---|---|
| 11 | 50 | 0 | 0 | 0 | 50 | 250 |
| 12 | 45 | 5 | 0 | 0 | 50 | 240 |

Ceramaterials EBS-1X

| | | | | | | |
|---|---|---|---|---|---|---|
| 13 | 50 | 0 | 0 | 0 | 50 | 240 |
| 14 | 45 | 5 | 0 | 0 | 50 | 240 |

### Example 5: Continuous Reactor+ Filtration

In this study, a 10 L bench-scale continuous electrochemical reactor is employed in which the electrodes are arranged at 1 cm apart with total of 7 sets. Each set include one cathode and one anode. Two electrode sets are made of graphite and provided for EO and five electrode sets are made of iron and aluminum and provided for EC. In a similar manner to the beaker scale experiment, the polarity is changed at the half-time and the treatment time calculated from the flow rate. To provide a continuous serpentine flow of the greywater sample through the reactor, alternating electrodes are shortened by 10 cm at the bottom end. On the remaining long electrodes, several 2 cm holes are made to facilitate the flow.

The electrochemical reactor stage is followed by a rapid settling stage through gravity. The final sample is collected at the outlet of the settling tank.

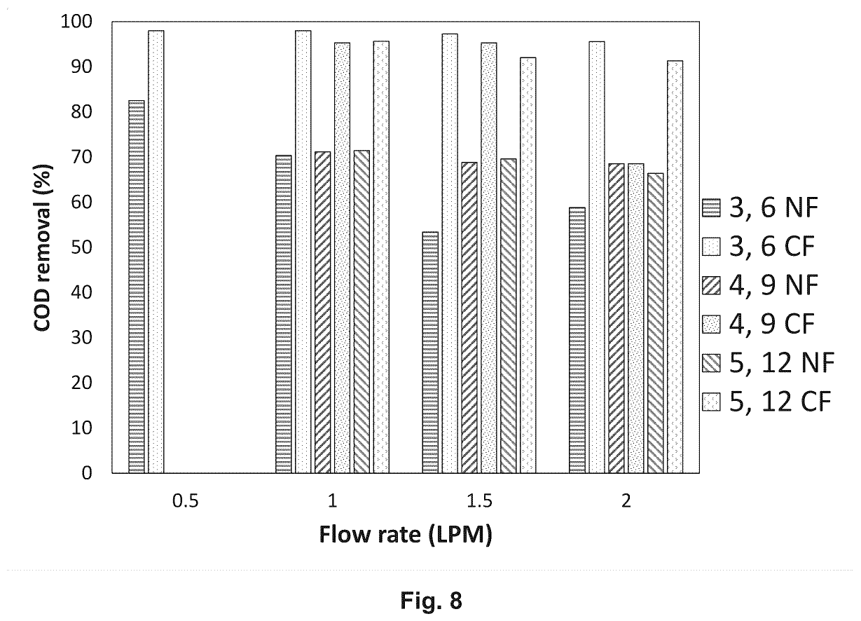

The graph in FIG. 8 illustrates the efficiency of COD removal under different combinations of flow rate and current densities when applied in 10 L bench-scale continuous reactor while treating synthetic greywater. Maximum COD removal after both nylon filtration (NF) (around 70%) and carbon filtration (CF) (around 95%) was observed while working with both 1 and 1.5 L/min flow rate and when the applied current for EO is varied between 9-12 A and for EC is 4-5 A. The nylon filter employed is a Cole-Parmer nylon membrane filter: 0.2 μm pore, 47 mm diameter from Cole-Parmer Canada (coleparmer.ca). The carbon filter employed is a Brita activated carbon and ion exchange resin cartridge.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. An electrochemical treatment module for the electrooxidation and electrocoagulation treatment of contaminants in greywater, the electrochemical treatment module comprising:
a tank having a bottom, a top, a first and a second end;
a plurality of first electrooxidation electrodes and a plurality of second electrocoagulation electrodes, wherein the plurality of first electrooxidation electrodes and the plurality of second electrocoagulation electrodes are located within the tank;
a waste water inlet located at the first end of the tank;
a discharge outlet located at the second end of the tank; and
a plurality of air/aeration inlets located along the bottom of the tank; wherein the electrochemical treatment tank is configured to oxidize and coagulate chemical contaminants for removal by sedimentation.

2. The system of claim 1, wherein the plurality of first electrooxidation electrodes are arranged sequentially in a first set and the plurality of second electrocoagulation electrodes are arranged in sequentially in a second set provided after the first set.

3. The system of claim 1, wherein the first electrooxidation electrodes and second electrocoagulation electrodes are provided in alternating arrangement.

4. The system of claim 1, wherein the first and second electrodes are arranged to ensure continuous serpentine flow through the tank.

5. The system of claim 4, wherein the serpentine flow is achieved through placement of gaps between the ends of electrodes and the tank walls and/or placement of holes in in the electrodes.

6. The system of any one claim 1, wherein the first electrooxidation electrodes are planar electrodes comprising graphite, boron doped diamond, mixed metal oxides or a graphene based composite.

7. The system of claim 1, wherein the second electrocoagulation electrodes are planar electrodes comprising aluminum, iron, or low carbon steel.

8. The system of claim 1, wherein the first and second electrodes are provided in an electrode core, wherein the electrode core comprises non-conductive side plates configured to hold the electrodes securely in position, and wherein the electrode core is configured for insertion and removal from the tank for electrode maintenance.

9. The system of claim 1, wherein the electrochemical treatment module further comprises a sedimentation tank in fluid communication with the discharge outlet of the primary treatment tank.

10. A multi-stage system for treating greywater, the system comprising:
an electrochemical treatment module comprising:
a tank having a bottom, a top, a first and a second end;
a plurality of first electrooxidation electrodes and a plurality of second electrocoaqulation electrodes, wherein the plurality of first electrooxidation electrodes and the plurality of second electrocoaqulation electrodes are located within the tank;
a waste water inlet located at the first end of the tank;
a discharge outlet located at the second end of the tank; and
a plurality of air/aeration inlets located along the bottom of the tank, wherein the electrochemical treatment module is configured for the electrooxidation and electrocoagulation treatment of chemical contaminants in greywater;
a pretreatment module for removing oil and grease from the greywater prior to treatment in the electrochemical treatment module; and
a filtration module for removing particulate and microbial contaminants and dissolved chemicals from the greywater following treatment in the electrochemical treatment module.

11. The multistage system of claim 10, wherein the filtration module comprising a multistage filtration system, wherein the multistage filtration system comprises:
a first filter stage for removing micron sized particles;
a second filter stage comprising an activated carbon/ion exchange resin filter;
a third filter stage for removing dissolved chemical contaminants; and
a fourth filter stage comprising an ultrafiltration membrane for removing nanoparticulates.

12. The multistage system of claim 11, wherein first filter stage is a polypropylene filter.

13. The multistage system of claim 11, wherein the third filter stage is a carbon filter.

14. The multistage system of claim 13, wherein the carbon filter is a graphene-enhanced carbon filter.

15. The multistage system of claim 10, wherein the ultrafiltration membrane is a hollow fiber ultrafiltration membrane.

16. The multistage system of claim 15, wherein the hollow fiber ultrafiltration membrane is a graphene-enhanced hollow fiber ultrafiltration membrane.

17. The multistage system of claim 10, wherein the plurality of first electrooxidation electrodes are arranged sequentially in a first set and the plurality of second electrocoagulation electrodes are arranged in sequentially in a second set provided after the first set.

18. The multistage system of claim 10, wherein the first electrooxidation electrodes and second electrocoagulation electrodes are provided in alternating arrangement.

19. The multistage system of claim 10, wherein the first and second electrodes are arranged to ensure continuous serpentine flow through the tank, wherein the serpentine flow is achieved through placement of gaps between the ends of electrodes and the tank walls and/or placement of holes in in the electrodes.

20. The multistage system of claim 10, wherein the first electrooxidation electrodes are planar electrodes comprising graphite, boron doped diamond, mixed metal oxides or a graphene based composite, and the second electrocoagulation electrodes are planar electrodes comprising aluminum, iron, or low carbon steel.
